(19) United States
(12) Patent Application Publication
(10) Pub. No.: US 2007/0271319 A1
(43) Pub. Date: Nov. 22, 2007

(54) Apparatus for an Method of Signal Processing

(76) Inventor: Jonathan Simon Richardson Smith, Marlow (GB)

Correspondence Address: Manelli Denison & Selter;Attn: William H. Bollman, 2000 M Street, NW, 7th Floor, Washington, DC, 20036, US

(21) Appl. No.: 11/663,652

(22) PCT Filed: Sep. 26, 2005
(86) PCT No.: PCT/GB05/03693

§ 371 Date: Mar. 23, 2007

(30) Foreign Application Priority Data
Sep. 24, 2004 (GB) 0421346.8

(51) Int. Cl. G06F 15/00

(52) U.S. Cl. 708/201; 708/204; 708/290

(57) ABSTRACT

A set of related methods of demodulating amplitude and frequency modulated signals. The emphasis is on using an iterative approach to separate an envelope signal and a frequency modulated signal from which a physically meaningful, non-negative instantaneous frequency can be derived. Three schemes are presented. The first scheme represents signals as the single product of an envelope signal and a frequency modulated signal, derived by iterative methods. The remaining schemes involve repeatedly smoothing the signal prior to demodulation. The signal is represented as being the sum of a set of component signals, each of which is the product of an envelope signal and a frequency modulated signal. For all three schemes the envelope and instantaneous frequency values can be presented in the form of the Demodulated Signal time-frequency representation.

### BACKGROUND

This invention relates to computer implemented procedures for representing signals as being the product of an envelope signal and a possibly frequency modulated signal with a constant envelope, or as a sum of a set of such products.

Data analysis has historically been dominated by Fourier analysis. Fourier analysis tells us that we can decompose any signal into a sum of component signals. Each of these component signals is a plane wave with a constant frequency, a constant phase, and a constant envelope. The Fourier approach is robust and widely used. However, it has some drawbacks. Fourier analysis of complicated non-stationary data often yields correspondingly complicated results, the data being represented as the sum of a very large number of component waves. Indeed, the description of signals as being the sum of a set of component plane waves, each of which has a constant frequency, can be seen as being rather non-physical. The Fourier approach is ill-suited to describing the time-varying frequency and energy exhibited by most natural signals. One alternative to Fourier analysis is to use the analytic signal [1] to define instantaneous frequency and instantaneous amplitude values. However, the analytic signal instantaneous frequency of non-stationary, natural data can often be very erratic, and of debatable physical significance [2, 3, 4].

### STATEMENT OF INVENTION

A set of related methods of processing a signal in order to decompose it into the product of a possibly frequency modulated signal with a constant envelope, and a separate, possibly time-varying, non-negative envelope signal, or into a set of such products. The first method comprises the steps of:
1) interpolating data points between the maxima of the absolute value of the signal, and, if necessary, smoothing those data points to form a non-negative envelope estimate;
2) dividing the original signal by the envelope estimate to form a possibly frequency modulated signal, which may have a constant envelope equal to 1;
3) repeating steps 1 and 2 on the resulting signal if step 2 does not generate a signal with such a constant envelope, and iterating until a signal which has a constant envelope which is equal to 1, or approximately equal to 1, is generated;
4) deriving instantaneous, possibly time-varying, instantaneous phase and frequency values from the signal derived according to steps 2 and 3;
5) multiplying together the successive envelope estimates generated by applying steps 2 and 3, to produce a final envelope, or dividing the original signal by the signal with a constant envelope equal to 1 generated by applying steps 2 and 3, in order to produce a final envelope;
6) displaying a combination of the derived instantaneous frequency, phase, and envelope values in the form of a Demodulated Signal time-frequency representation.

The second method comprises the steps of:
1) smoothing the input signal using moving averaging;
2) subtracting the smoothed version of the signal from the original input signal;
3) processing the resulting signal according to the first method described previously in this patent application;
4) if the smoothed version of the original input signal is not constant, or monotonically increasing or monotonically decreasing, treating this smoothed signal as the new input signal, and iterating steps 1, 2, and 3 using a progressively longer moving average on this smoothed signal and subsequently derived smoothed signals until the final smoothed signal is constant, or monotonically increasing or monotonically decreasing.

The third method, called the Local Mean Decomposition (LMD), comprises the steps of:
1) calculating the local mean of each half-wave oscillation of the original input signal;
2) calculating the local magnitude of each half-wave oscillation of the original input signal;
3) smoothing the local means using moving averaging to form a smoothed local mean function;
4) smoothing the local magnitudes using moving averaging to form a smoothed local magnitude function or initial envelope estimate, the degree of smoothing being the same as that used to produce the smoothed local mean function in step 3;
5) subtracting the local mean function derived in step 3 from the original input signal;
6) dividing the resulting signal by the local magnitude function (initial envelope estimate) derived in step 4;
7) repeating steps 1-6 on the resulting signal if this signal does not have a constant envelope equal to 1, or approximately equal to 1, and iterating until a signal which has a constant envelope which is equal to 1, or approximately equal to 1, is generated;
8) deriving instantaneous, possibly time-varying, instantaneous phase and frequency values from the signal derived according to steps 6 and 7;
9) multiplying together the successive local magnitude functions (envelope estimates) generated by applying steps 1-7, to produce a final envelope;
10) multiplying the final envelope produced using step 9, with the possibly frequency modulated signal with a constant, or approximately constant, envelope produced using steps 6 and 7, to form a product function;
11) Subtracting this product function from the original signal, and processing the resulting signal according to steps 1-10, if this resulting signal is not constant, or monotonically increasing or monotonically decreasing, and iterating steps 1-10 for all such subsequently derived signals, until the final signal which results from the repeated application of steps 1-10 is either constant or monotonically increasing or monotonically decreasing;
12) displaying a combination of the derived instantaneous frequency, phase, and envelope values in the form of a demodulated signal time-frequency representation.

### ADVANTAGES

Unlike Fourier analysis, which decomposes complicated non-stationary signals into a very large number of component waves, the proposed schemes represent such signals either as the single product of a possibly frequency modulated signal and an envelope signal, or as the sum of a set of a finite number of such products. A time-varying instantaneous phase and instantaneous frequency can then be derived from the frequency modulated signal. Such product representations often provide a much more concise description of the signal than that offered by Fourier analysis: at any instant in time the signal can be described either by just two values, the value of the envelope and the instantaneous frequency value, or by a limited number of pairs of these values. Most importantly, the instantaneous frequency should be physically meaningful because it is derived from a frequency modulated signal with a flat envelope. By contrast, schemes which, for example, involve the use of the Hilbert transform and the analytic signal often produce an erratic, physically meaningless instantaneous frequency containing infinite positive or negative spikes.

Having derived instantaneous phase, instantaneous frequency, and instantaneous amplitude values, these can then be displayed in the form of a Demodulated Signal time-frequency representation. Such a representation provides perfect time-frequency localization of the signal's energy, in contrast to such Fourier-based time-frequency representations as the spectrogram or the scalogram, in which the energy of the signal is smeared over the time-frequency plane.

### INTRODUCTION TO DRAWINGS

Examples of the proposed schemes will now be described by referring to the accompanying drawings.

FIG. 1. A test signal (equation (1) with (ωₐ/2π=1, ω_{b}/2π=2, Aₐ=1, and A_{b}=1) is shown in the top plot as the solid black line with an envelope (dotted line) derived by iteration using smoothed local magnitudes. The lower plot shows the corresponding frequency modulated signal. The test signal can be obtained by multiplying the frequency modulated signal by the envelope.

FIG. 2. The top plot shows a test signal (equation (1) with ωₐ/2π=2, ω_{b}/2π=10, Aₐ=1, and A_{b}=0.5) in black and the cubic spline envelope as the dotted line. The spline is set equal to the absolute value of the signal for all those half-wave oscillations which do not cross zero, and is attached to the maximum points of the absolute value of the signal for all the oscillations which do cross zero. The signal is then divided by its spline envelope to produce the frequency modulated signal shown in the lower plot.

FIG. 3. Clearly, in this example, the cubic spline does not “envelop” the test signal, and so the resulting frequency modulated signal estimate does not itself have a flat (constant) envelope. Consequently there is a need to iterate.

FIG. 4. The cubic spline envelope estimate after five iterations is shown as the dotted line in the top plot. The envelope now envelops the test signal. The resulting frequency modulated signal consequently has a flat envelope.

FIG. 5. The top plot shows the instantaneous phase of the cubic spline derived frequency modulated signal shown in FIG. 2. The middle plot shows the unwrapped instantaneous phase. The bottom plot shows the resulting instantaneous frequency.

FIG. 6. The top plot shows the instantaneous phase of the cubic spline derived frequency modulated signal shown in FIG. 4. The middle plot shows the unwrapped instantaneous phase. The bottom plot shows the resulting instantaneous frequency.

FIG. 7. The top plot shows the envelope estimate formed using linear interpolation between the maximum points of the absolute value of the test signal. The lower plot shows linear interpolation envelope estimate after smoothing.

FIG. 8. The local magnitudes are plotted as straight lines in the top plot. They extend between successive zero crossings of the signal. The smoothed local magnitude function, created by repeatedly applying a moving average to the local magnitudes is shown as the dotted line. The test signal, shown in black, is then divided (amplitude demodulated) by the local magnitude function to produce the frequency modulated signal estimate shown in the lower plot. The procedure is then repeated for the frequency modulated signal estimate.

FIG. 9. If the signal contains half-wave oscillations which do not cross zero, the midpoints between successive extrema of the absolute value of the signal are calculated. The local magnitudes are then set to extend between these midpoints. For these oscillations that do not cross zero, the local magnitudes are set equal to the maxima and the minima of the absolute value of the signal. These local magnitudes can then be smoothed.

FIG. 10. The top plot shows an alternative approach to deriving an envelope using local magnitudes. If a half-wave oscillation does not cross zero, the envelope is set equal to the signal. Otherwise the local magnitudes are plotted as straight lines extending between successive extrema. If necessary the result can then be smoothed (lower plot). After several iterations an envelope which envelops the signal can be derived.

FIG. 11. The top plot shows a close-up of the local magnitudes in FIG. 9. Clearly the endpoints overlap. In order to form a continuous function the right (or left) endpoint of each local magnitude can be removed (middle plot). Alternatively both endpoints can be replaced by a single point representing their average value (shown as the black dots in the bottom plot).

FIG. 12. The top plot shows the final smoothed local magnitudes derived envelope obtained by iteration. The lower plot shows the corresponding frequency modulated signal.

FIG. 13. If the signal just clips zero, as shown in the left plot, a spike may occur in the envelope calculated according to one of the three main methods described in the section of the patent description on the iterative derivation of envelopes and frequency modulated signals. In order to avoid this it may be necessary to smooth the data locally (by using moving averaging, for example) to lift the signal away from zero (right plot, shown as the dotted line).

FIG. 14. This figure shows the Demodulated Signal time-frequency representation of the cubic spline derived instantaneous frequency and envelope values shown in FIGS. 4 and 6 for the test signal shown in FIG. 4. The grey scale represents the envelope values.

FIG. 15. This figure shows a sample portion of EEG data. The experimental stimulus lasts from 0-0.5 seconds.

FIG. 16. The eight product functions obtained by progressively smoothing the EEG signal shown in FIG. 15. The associated envelopes produced using cubic splines are shown as dotted lines.

FIG. 17. The instantaneous frequencies corresponding to the product functions shown in FIG. 16.

FIG. 18. The Demodulated Signal time-frequency representation of the cubic spline derived envelope and instantaneous frequency values shown in FIGS. 16 and 17.

FIG. 19. The top plot shows the local means in black, and the smoothed local mean function as the thick solid line. The lower plot shows the corresponding local magnitudes as straight lines and the resulting smoothed local magnitude function (the initial envelope estimate).

FIG. 20. The top plot shows the initial product function estimate obtained by subtracting the smoothed local mean function from the original data. The corresponding envelope estimate is shown as the dotted line. The lower plot shows the final version of the first product function and its associated envelope.

FIG. 21. The top plot shows the initial estimate of the first frequency modulated signal. The lower plot shows the final version.

FIG. 22. The three highest frequency product functions and their associated envelopes (dotted lines) obtained using the Local Mean Decomposition approach.

FIG. 23. The instantaneous frequency results for the product functions shown in the previous figure.

FIG. 24. Local Mean Decomposition Demodulated Signal time-frequency representation obtained using the envelope and instantaneous frequency results shown in FIGS. 22 and 23.

FIG. 25. This figure shows an alternative method of smoothing the local means (top plot) and the local magnitudes (bottom plot) using linear interpolation.

FIG. 26. This figure shows an example of an apparatus.

### DETAILED DESCRIPTION

Introduction

The extraction of meaning from data is fundamental to our interpretation of the physical world. In particular, we can interpret data in terms of the frequency of its oscillation. Electromagnetic waves, for example, are defined in terms of their frequency. The dominant method of analysing data over the past 200 years has been Fourier analysis. In Fourier analysis, frequency is interpreted as being a constant, time-invariant quantity: all data can be decomposed into a sum of plane waves, the frequency of oscillation of each plane wave being constant.

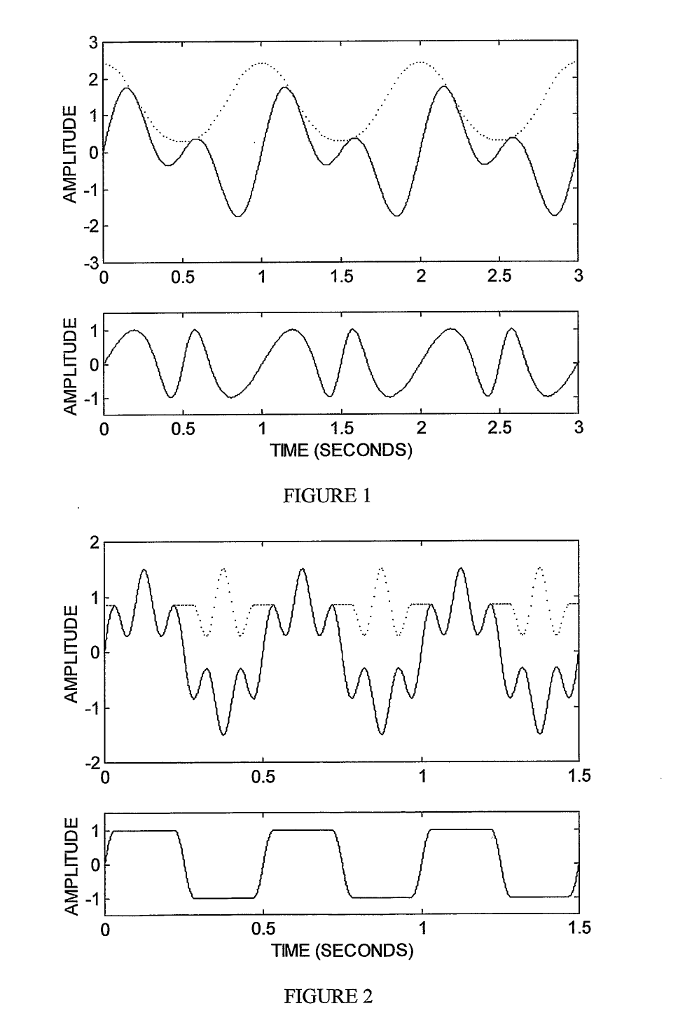

Suppose we listen to a bird's chirp. We may hear the frequency of the chirp increasing or decreasing over time. Fourier analysis is ill-suited to describing the apparently changing frequency of such natural signals. However, the Fourier approach is just one way of interpreting signals. Consider the signal illustrated in FIG. 1. Fourier analysis will tell us that the signal is the sum of two tones, one with twice the frequency of the other. However, this signal can also be seen as being the product of the envelope signal and the frequency modulated signal shown in the upper and lower plots. Such a product representation is the natural home of the concept of time-varying frequency, since a physically meaningful, non-negative instantaneous frequency can then be derived from the frequency modulated signal.

Iterative Derivation of an Envelope and a Frequency Modulated Signal

The attempt to define a physically meaningful instantaneous frequency stretches back more than 70 years. Since the 1940's much attention has been focussed on the instantaneous frequency derived from the so-called analytic signal. However, the analytic signal instantaneous phase can contain discontinuities (phase jumps) which produce spikes in the resulting instantaneous frequency. Such non-physical spikes in the instantaneous frequency are an unavoidable consequence of using the Hilbert transform to define an imaginary signal to form the analytic signal from which instantaneous phase and amplitude are derived. Rather than attempting to find an alternative to the Hilbert transform to generate an imaginary signal, it is easier to focus on defining an alternative to the analytic signal instantaneous amplitude. For many amplitude and frequency modulated signals the envelope is not well defined. It is merely a visual interpolation of points between the extrema of the signal. Once we have chosen the envelope, the phase is uniquely defined. So the key to defining the instantaneous frequency for a signal is to first choose an appropriate envelope. Using the analytic signal results in a particular choice of envelope and phase, but the resulting instantaneous frequency can often be physically unappealing.

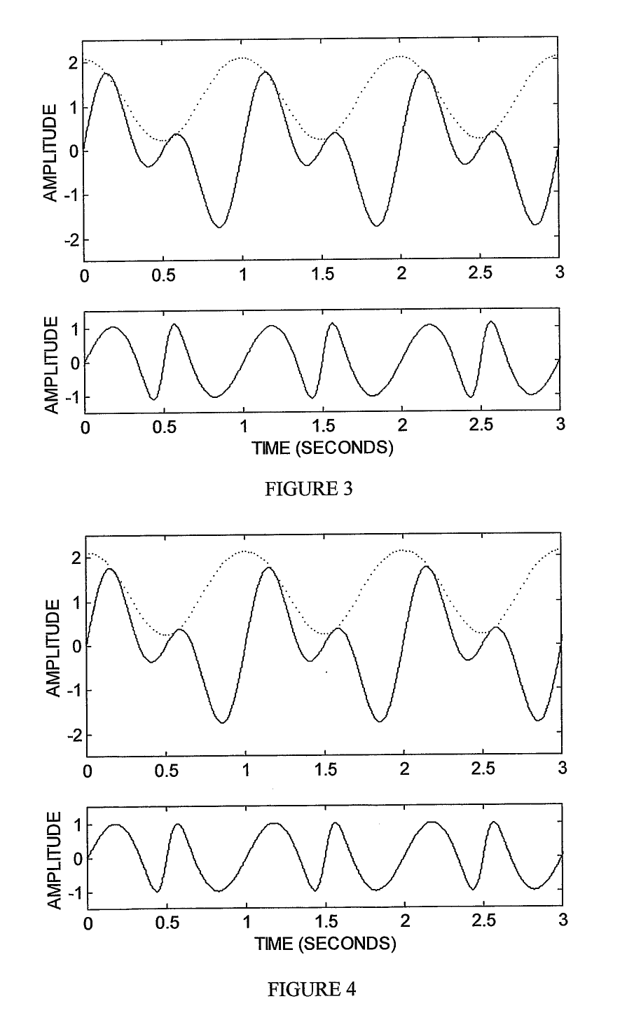

We can impose two constraints on our choice of envelope: it must envelop the signal, and it must be non-negative. There are a number of ways of achieving this objective.
1) A spline can be attached to the maximum points of the absolute value of the signal x(t). Where the half-wave oscillations of the signal do not cross zero, the cubic is set equal to the signal between the successive extrema of those particular oscillations. Consider the signal shown in FIG. 2. This signal can be considered to be the sum of two tones with constant frequencies ωₐ and ω_{b}, and constant envelopes Aₐ and A_{b}:
   x(t)=Aₐ sin ωₐt+A_{b} sin ω_{b}t (1)
   with ωₐ/2π=2, ω_{b}/2π=10, Aₐ=1, and A_{b}=0.5 (FIG. 2, upper plot). If the resulting envelope a₁(t) actually “envelops” the absolute value of the signal, then dividing the signal by the envelope will produce a purely frequency modulated signal s₁(t) (FIG. 2, lower plot). However, consider the signal given by equation (1) with ωₐ/2π=1, ω_{b}/2π=2, Aₐ=1, and A_{b}=1 (FIG. 3, upper plot). In this example the cubic spline-based envelope estimate does not envelop the signal, and so the resulting frequency modulated signal estimate does not have a flat envelope, i.e. a₂(t)≠1 (FIG. 3, lower plot). It will therefore be necessary to iterate. A cubic spline is attached to the maxima of the absolute value of the frequency modulated signal estimate s₁(t).

This cubic spline envelope a₂(t) is then used to demodulate s₁(t). The whole process is repeated until a purely frequency modulated signal with a flat envelope aₙ(t)=1 is generated:

$${s}_{1} ( t ) = x ( t ) / {a}_{1} ( t ) , \\ {s}_{2} ( t ) = {s}_{1} ( t ) / {a}_{2} ( t ) , \\ ⋮ \\ {s}_{n} ( t ) = {s}_{n - 1} ( t ) / {a}_{n} ( t ) . \qquad ( 2 )$$

The original signal can be divided by this frequency modulated signal to derive a corresponding envelope:

$$\begin{matrix}a ( t ) = {a}_{1} ( t ) {a}_{2} ( t ) … {a}_{n} ( t ) \\ = {\prod }_{j = 1}^{n} {a}_{j} ( t ) \\ = x ( t ) / {s}_{n} ( t )\end{matrix} \qquad ( 3 )$$

With the objective for these schemes being that:

$${lim}_{n -> ∞} {a}_{n} ( t ) = 1 \qquad ( 4 )$$

FIG. 4 shows the cubic spline envelope and the corresponding frequency modulated signal obtained after five iterations for the test signal shown in FIG. 3. Given the frequency modulated signal sₙ(t), it is straightforward using standard frequency demodulation methods to derive a non-negative instantaneous frequency. The frequency modulated signal can be written as:
sₙ(t)=cos φ(t) (5)
where φ(t) is the instantaneous phase:
φ(t)=arccos(sₙ(t)) (6)

The instantaneous frequency ω(t) is then given by:

$$ω ( t ) = \frac{ⅆ φ ( t )}{ⅆ t} \qquad ( 7 )$$

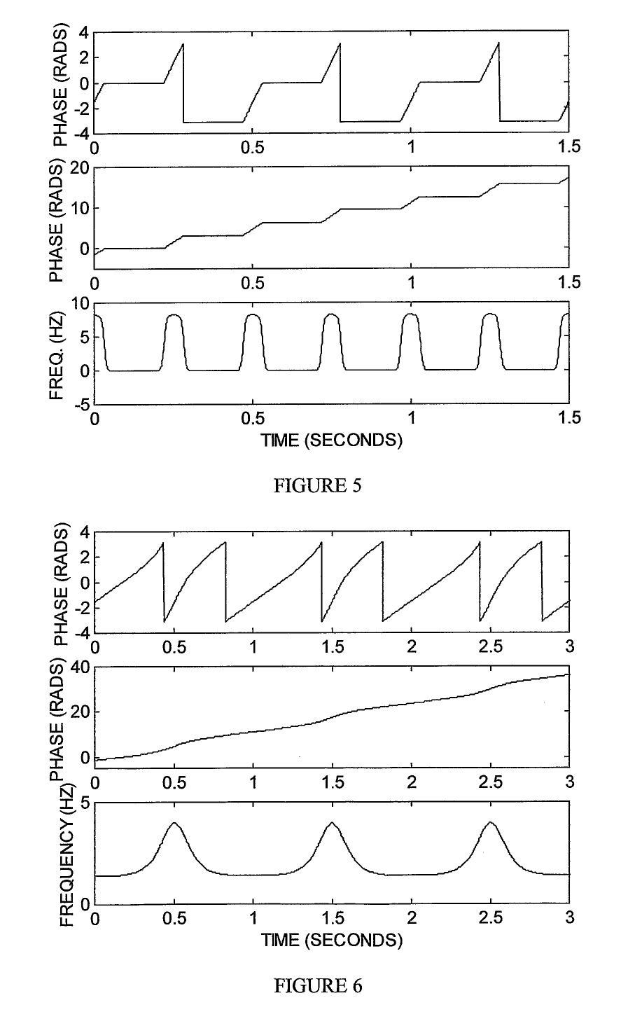

The instantaneous phase and instantaneous frequency results for the two test signals are shown in FIGS. 5 and 6. The original signal is now represented as being the product of a purely frequency modulated signal and an envelope signal:
x(t)=a(t)cos φ(t) (8)

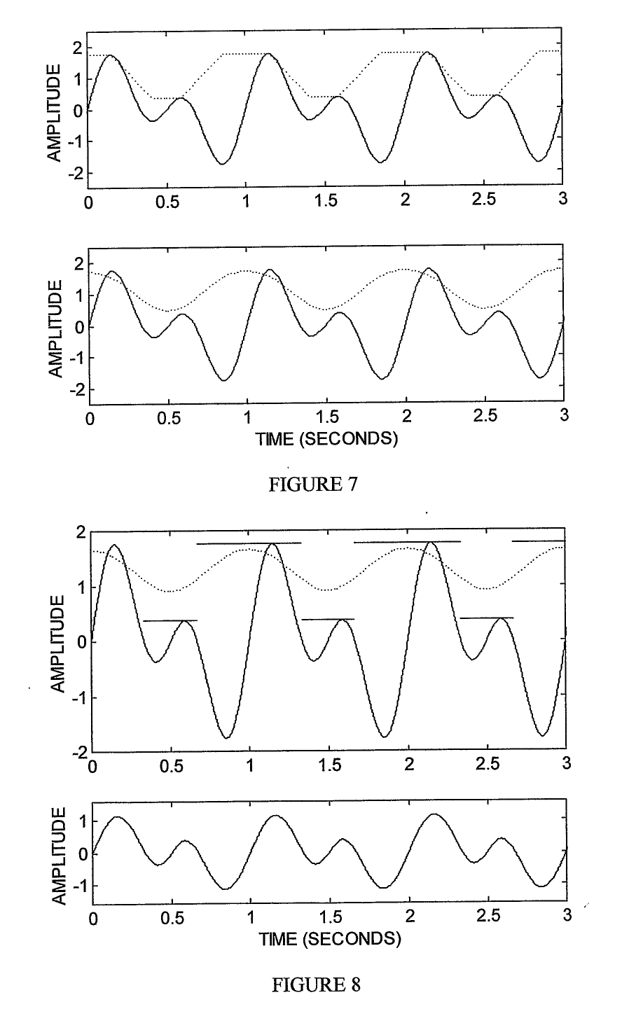

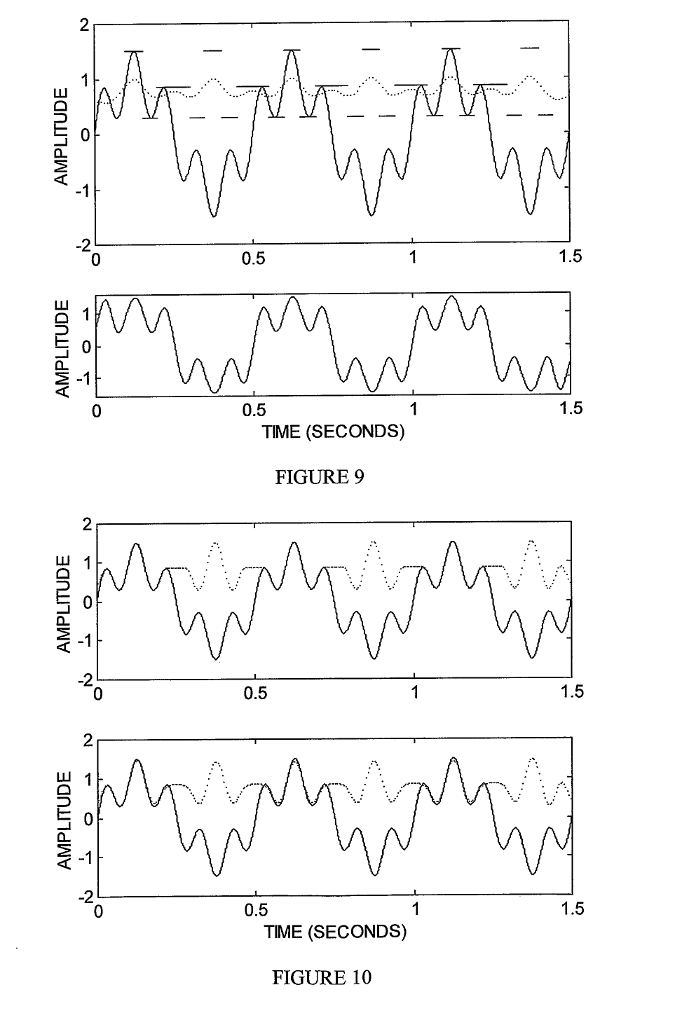

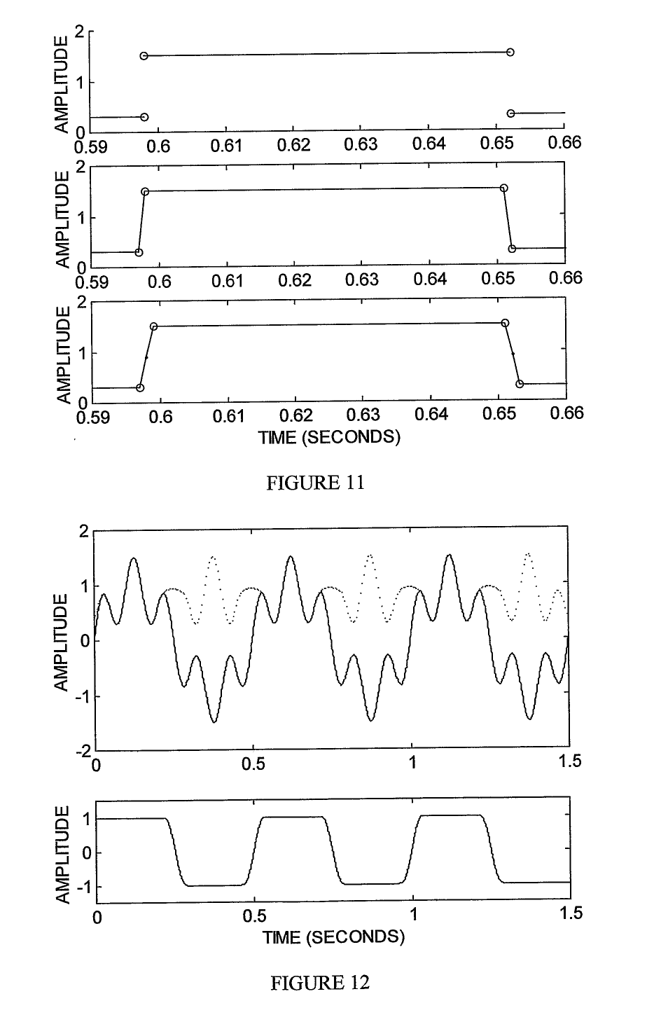

It may sometimes be the case that “overshoots” cause the spline to take on negative values. In this case the absolute value of the spline can be taken, and the result smoothed using moving averaging to lift it away from zero.
2) An alternative to using, for example, cubic splines to derive an envelope for signals, is to simply linearly interpolate points between the maxima of the absolute value of the signal (FIG. 7, upper plot) and then repeatedly smooth the result using moving averaging until a smoothly varying envelope estimate is obtained (FIG. 7, lower plot). As for the cubic splines, an iterative approach should be adopted using equations (2) and (3). This approach avoids the negative overshoots which can occur with splines.
3) A further variation on the same theme is to obtain an initial estimate of a non-negative envelope by smoothing the local magnitudes of the signal, again using moving averaging. The local magnitudes are defined as being the maxima of the absolute value of the signal, and are plotted in FIG. 8 as straight lines extending between successive zero-crossings of the signal. If an oscillation does not cross zero the local magnitudes can be set equal to the value of the local maxima and minima, and are plotted in FIG. 9 as straight lines extending between the midpoints of the successive extrema. We wish to form a smoothly varying envelope from the local magnitudes. Because the endpoints of the local magnitudes overlap (FIG. 11, top plot), in order to produce a continuous function it is necessary to set the right endpoint of the local magnitude aᵢ and the left endpoint of the succeeding local magnitude aᵢ₊₁ equal to (aᵢ+aᵢ₊₁)/2 (FIG. 11, bottom plot). Alternatively, the right endpoint of each local magnitude aᵢ could simply be set equal to aᵢ₊₁ (FIG. 11, middle plot), or vice versa. In either case, a moving average can then be repeatedly applied to the resulting function until a smoothly varying envelope estimate a(t) is produced (FIG. 9, shown as the dotted line in the top plot). The smoothing should continue until the local magnitudes are no longer constant. If all the local magnitudes are equal initially, no such smoothing will be required. It should be noted that the degree of smoothing is affected by the length of the moving averaging. Initially the length of the moving averaging can be set equal to the maximum distance between the successive extrema of the signal. The local magnitudes are smoothed using this length of moving average until a smoothly varying envelope estimate a(t) is obtained. In order to ensure that the envelope actually envelops the signal it will usually be necessary to adopt the iterative demodulation approach of equations (2) and (3). So the original signal is then demodulated using the envelope estimate a(t). For the next iteration the length of the moving average can be set equal to half that of the previous moving average. Again, the local magnitudes are repeatedly smoothed using this length of moving average until a smoothly varying estimate of the frequency modulated signal is obtained. For each iteration the length of the moving average can be halved. The final iteration simply consists of setting the envelope aₙ(t) equal to the frequency modulated signal estimate sₙ₋₁(t) for those half-wave oscillations of sₙ₋₁(t) which do not cross zero. For those half-wave oscillations of sₙ₋₁(t) which do cross zero, the envelope should be set equal to one. FIG. 12 shows the result of applying this method to one of the test signals. The final envelope is shown as the dotted line in the upper plot, and the corresponding frequency modulated signal is shown in the lower plot. The instantaneous phase and frequency can then be calculated from the frequency modulated signal according to equations (5), (6), and (7). It should be noted that an alternative method of deriving a signal envelope using local magnitudes is to set the envelope/local magnitude function equal to the signal for those half-wave oscillations which do not cross zero. Otherwise the local magnitudes are plotted as straight lines extending between successive extrema (FIG. 10, top plot). If necessary the result can then be smoothed (FIG. 10, lower plot). After several iterations an envelope which envelops the signal can be derived.

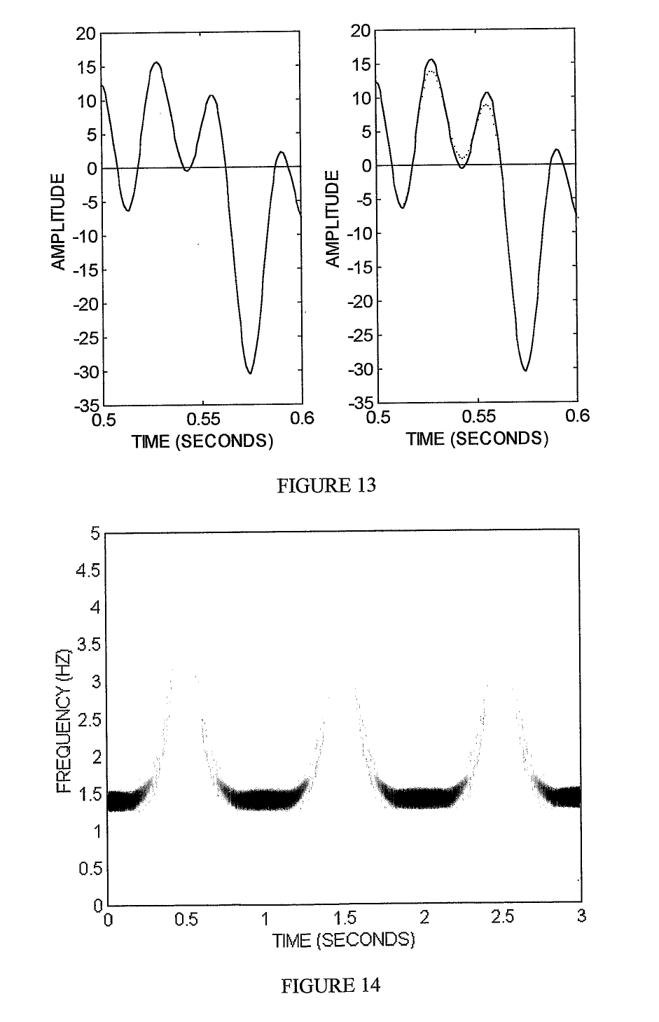

For each of the three approaches described above, it is possible that if the signal just clips zero (FIG. 13, left plot) a large spike can occur in the corresponding envelope. In order to avoid this possibility it may be necessary to lift the signal away from zero by smoothing it locally (by using moving averaging, for example) prior to processing (FIG. 13, right plot). The idea of smoothing the data more generally to separate it into a set of signals each with progressively lower frequency is examined in the following sections.

One advantage that the product representation of a signal has compared with Fourier analysis is its concision. Even the most complicated aperiodic amplitude and frequency modulated signal can be represented by just two values: the instantaneous amplitude and the instantaneous frequency. The instantaneous frequency and the corresponding envelope can be displayed together in single plot in the form of a Demodulated Signal time-frequency representation. The Demodulated Signal time-frequency representation for the test signal shown in FIG. 4 analysed using the iterative spline approach is shown in FIG. 14. The grey scale represents envelope variation or energy. The envelope and instantaneous frequency are shown independently in FIGS. 4 and 6 respectively. We can also calculate a Demodulated Signal spectrum analogous to the Fourier spectrum:

$$DS ( ω ) = {\int }_{0}^{T} DS ( ω , t ) ⅆ t \qquad ( 9 )$$

where T is the length of the data, and DS(ω, t) is the Demodulated Signal time-frequency representation.
Decomposing Data into a Sum of Product Functions

The scheme described in the previous section, which can be implemented in three different ways, decomposes the signal into the product of an envelope and a possibly frequency modulated signal, from which the instantaneous frequency can be derived. So at each instant in time, the signal is represented by two values: the value of the instantaneous frequency, and the value of the envelope at that instant. In particular, those oscillations of the signal which do not cross zero between their successive extrema are designated as being amplitude modulations, and are effectively incorporated into the envelope of the signal (see, for example, the envelope in FIG. 2). The instantaneous frequency thus derived echoes the zero-crossing frequency of the signal, i.e. the frequency is defined with reference to zero, and the envelope is symmetrical with respect to zero. If we wish to analyse those oscillations that do not cross zero in terms of their frequency we need to change the zero reference of the signal.

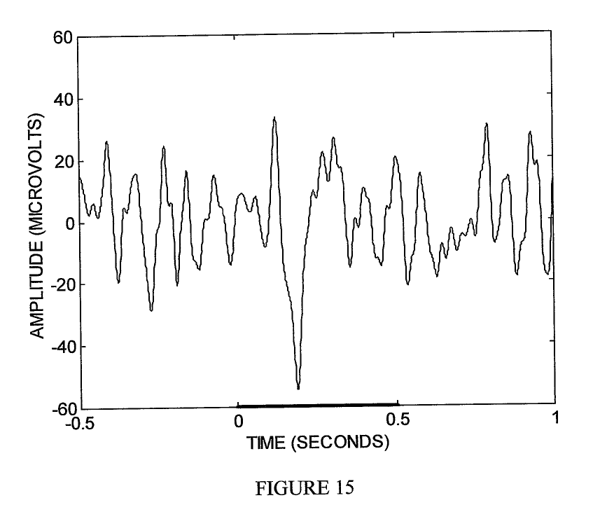

Consider the sample electroencephalogram (EEG) data shown in FIG. 15. The data needs to be progressively smoothed. A moving average approach can again be adopted. The length of the moving average can be progressively doubled. In this example, the EEG data is initially smoothed with a two point moving average. The smoothed data u₁(t) is then subtracted from the original EEG signal to get a high frequency product function PF₁(t). An envelope and phase for PF₁(t) is then derived by the method of equations (2) and (3). The smoothed data u₁(t) is now smoothed further using a four point moving average to produce u₂(t) which is subtracted from u₁(t) to give a second product function PF₂(t) for which envelope and phase values can be calculated. So the procedure is:

$${PF}_{1} ( t ) = x ( t ) - {u}_{1} ( t ) , \\ {PF}_{2} ( t ) = {u}_{1} ( t ) - {u}_{2} ( t ) , \\ ⋮ \\ {PF}_{k} ( t ) = {u}_{k - 1} ( t ) - {u}_{k} ( t ) . \qquad ( 10 )$$

The smoothing continues until the smoothed data is either constant, or monotonically increasing or decreasing. The scheme is complete in the sense that the original signal can be recovered according to:

$$x ( t ) = {\sum }_{i = 1}^{k} {PF}_{i} ( t ) + {u}_{k} ( t ) \qquad ( 11 )$$

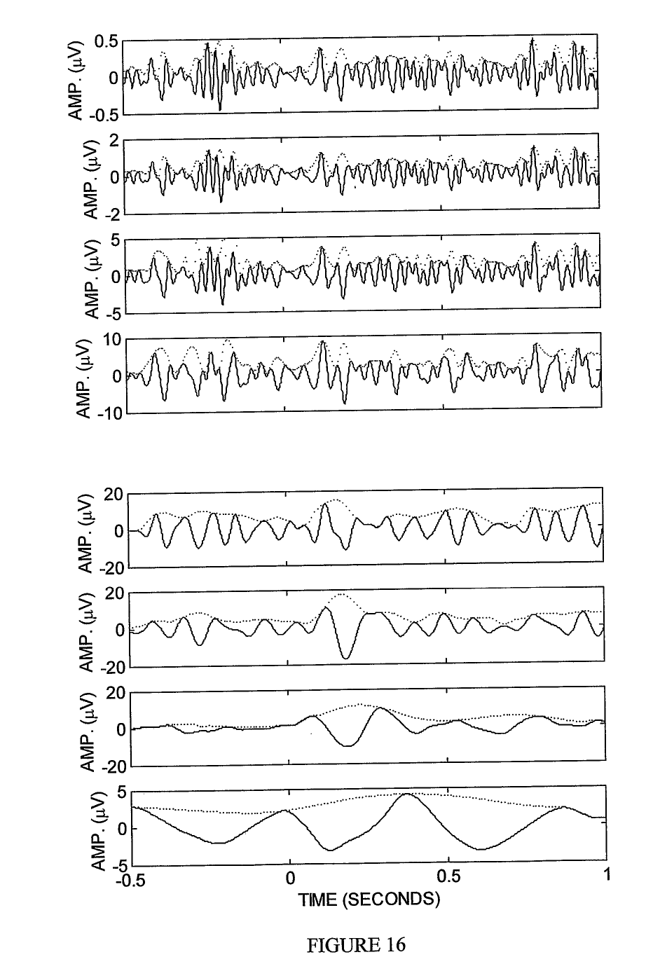

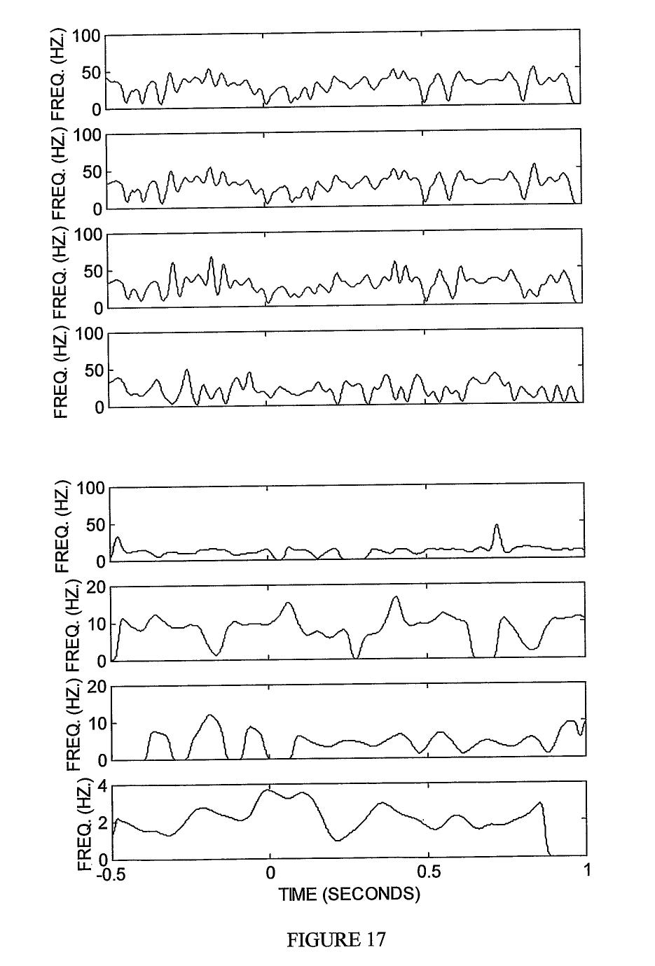

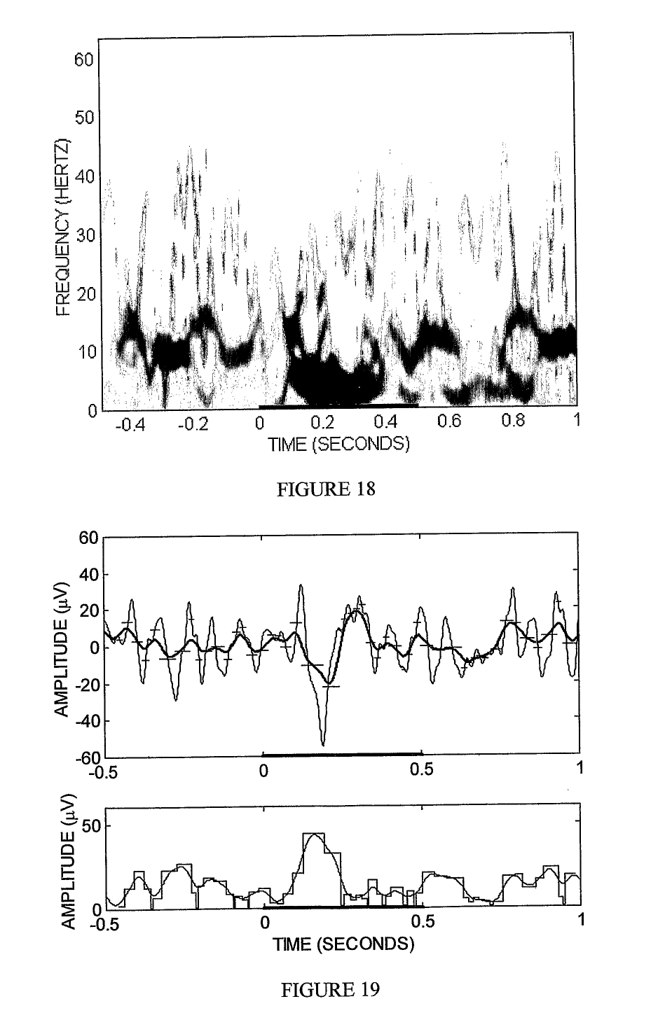

The eight product functions obtained for the EEG data using this approach are shown in FIG. 16. In this particular example the cubic spline envelope approach has been used in equations (2) and (3), but any of the other methods described in the section on the iterative derivation of envelopes and frequency modulated signals could also be used. The envelopes of the product functions are shown as dotted lines in FIG. 16. The corresponding instantaneous frequency values are shown in FIG. 17. The instantaneous frequencies and their associated envelope signals are shown plotted together in the form of the Demodulated Signal time-frequency representation in FIG. 18.

The Local Mean Decomposition

An alternative approach to describing the frequency of an oscillation is to characterize the frequency by the time lapse between the successive extrema of the oscillation [5]. The smoothing process described above can be modified to take account of those characteristic time scales. As already mentioned, each oscillation needs to be forced to cross zero. This can be achieved in a number of ways. For example, the mean of the maximum and minimum points of each half-wave oscillation can be calculated. So the ith mean value mᵢ of each two successive extrema nᵢ and nᵢ₊₁ is given by:

$${m}_{i} = \frac{{n}_{i} + {n}_{i + 1}}{2} \qquad ( 12 )$$

The local means of the sample EEG data are shown in the upper plot of FIG. 19 plotted as straight lines extending between successive extrema. So instead of smoothing the data itself as in the previous method, the local means are smoothed to form a continuously varying local mean function m(t) (shown as the thick solid line in FIG. 19). The overlapping endpoints of the local means are treated in the same way as described previously for the local magnitudes. A corresponding envelope estimate can also be derived. For this scheme the local magnitude of each half wave is given by:

$${a}_{i} = \frac{\vert {n}_{i} - {n}_{i + 1} \vert}{2} \qquad ( 13 )$$

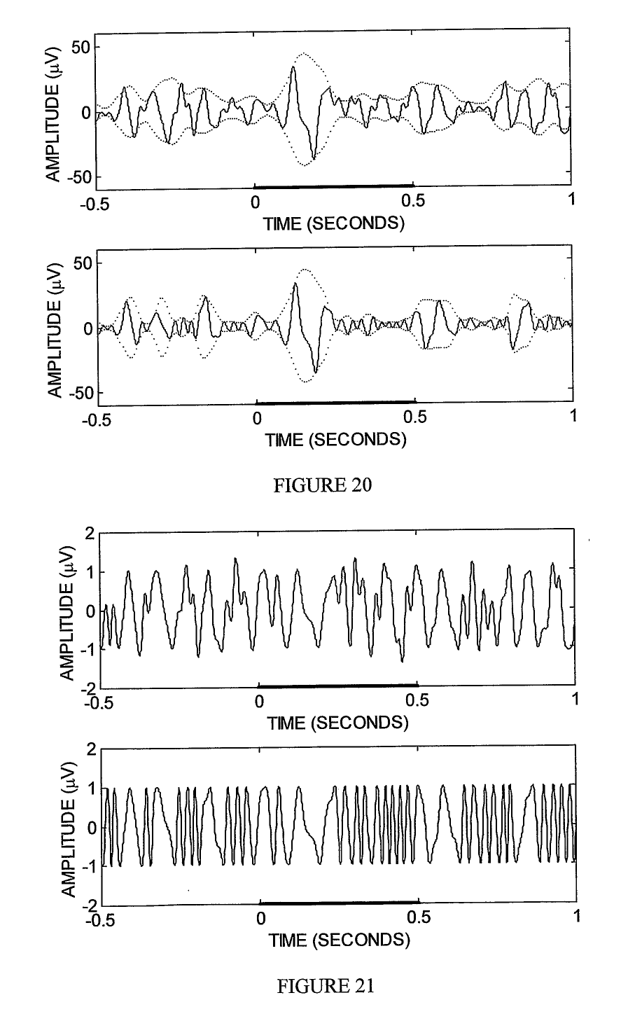

The local magnitudes are smoothed in the same way and to the same degree as the local means to form an envelope function a(t) (shown in FIG. 19, lower plot). This initial envelope estimate will be denoted by a₁₁(t) and the initial mean will be denoted by m₁₁(t). Having obtained an initial envelope estimate and an initial mean, m₁₁(t) is then subtracted from the original data x(t), the resulting signal being denoted by h₁₁(t):
h₁₁(t)=x(t)−m₁₁(t) (14)
h₁₁(t) is shown in the upper plot of FIG. 20. h₁₁(t) is then amplitude demodulated by dividing it by a₁₁(t):

$${s}_{11} ( t ) = \frac{{h}_{11} ( t )}{{a}_{11} ( t )} \qquad ( 15 )$$

s₁₁(t) is shown in the upper plot of FIG. 21. The envelope a₁₂(t) of s₁₁(t) is then calculated. If a₁₂(t)≠1 the process needs to be repeated. A smoothed local mean m₁₂(t) is calculated for s₁₁(t), subtracted from s₁₁(t), and the resulting function amplitude demodulated. The iteration process continues until a purely frequency modulated signal s₁ₙ(t) is obtained:

$$\begin{matrix}{h}_{11} ( t ) = x ( t ) - {m}_{11} ( t ) , \\ {h}_{12} ( t ) = {s}_{11} ( t ) - {m}_{12} ( t ) , \\ ⋮ \\ {h}_{1 n} ( t ) = {s}_{1 ( n - 1 )} ( t ) - {m}_{1 n} ( t ) , \\ where \text{:} & ( 16 ) \\ {s}_{11} ( t ) = {h}_{11} ( t ) / {a}_{11} ( t ) , \\ {s}_{12} ( t ) = {h}_{12} ( t ) / {a}_{12} ( t ) , \\ ⋮ \\ {s}_{1 n} ( t ) = {h}_{1 n} ( t ) / {a}_{1 n} ( t ) . & ( 17 )\end{matrix}$$

s₁ₙ(t) is shown in the lower plot of FIG. 21. The corresponding envelope is given by:

$$\begin{matrix}{a}_{1} ( t ) = {a}_{11} ( t ) {a}_{12} ( t ) … {a}_{1 n} ( t ) \\ = {\prod }_{j = 1}^{n} {a}_{1 j} ( t )\end{matrix} \qquad ( 18 )$$

where the objective is that:

$${lim}_{n -> ∞} {a}_{1 n} ( t ) = 1 \qquad ( 19 )$$

a₁(t) is shown as the dotted line in the lower plot of FIG. 20. Given the frequency modulated signal s₁ₙ(t), the instantaneous frequency can be derived according to equations (5), (6), and (7). The frequency modulated signal can be written as:
s₁ₙ(t)=cos φ₁(t), (20)
where φ₁(t) is the instantaneous phase:
φ₁(t)=arccos(s₁ₙ(t)). (21)

In order to calculate a meaningful instantaneous phase, it is important that −1≦s₁ₙ(t)≦1. It is sufficient to stop the iteration process when a₁ₙ(t)≈1 and then set all extrema of s₁ₙ(t) equal to ±1. It should be noted that the instantaneous phase should be set to range between ±π. The instantaneous frequency ω₁(t) can then be derived from the unwrapped phase as:

$${ω}_{1} ( t ) = \frac{ⅆ {φ}_{1} ( t )}{ⅆ t} . \qquad ( 22 )$$

s₁ₙ(t) is then multiplied by the envelope function a₁(t) to give a product function PF₁(t):
PF₁(t)=a₁(t)s₁ₙ(t) (23)
PF₁(t) is shown in the lower plot of FIG. 20. This product function is then subtracted from the original data x(t) resulting in a new function u₁(t), which represents a smoothed version of the original data since the highest frequency oscillations have been removed from it. u₁(t) now becomes the new data and the whole process is repeated k times until uₖ(t) is either constant, or monotonically increasing or decreasing:

$${u}_{1} ( t ) = x ( t ) - {PF}_{1} ( t ) , \\ {u}_{2} ( t ) = {u}_{1} ( t ) - {PF}_{2} ( t ) , \\ ⋮ \\ {u}_{k} ( t ) = {u}_{k - 1} ( t ) - {PF}_{k} ( t ) . \qquad ( 24 )$$

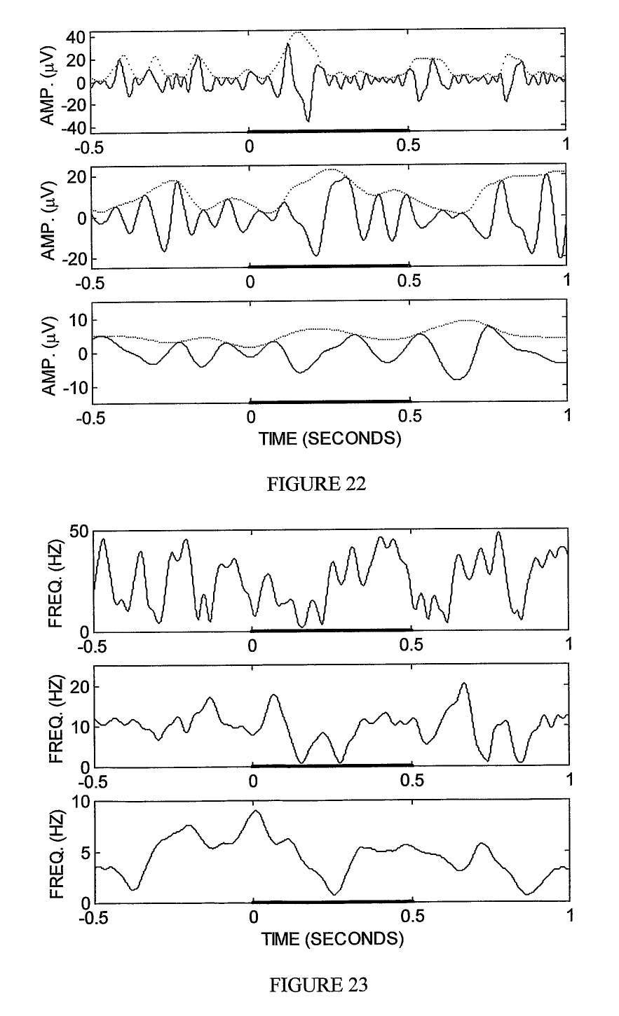

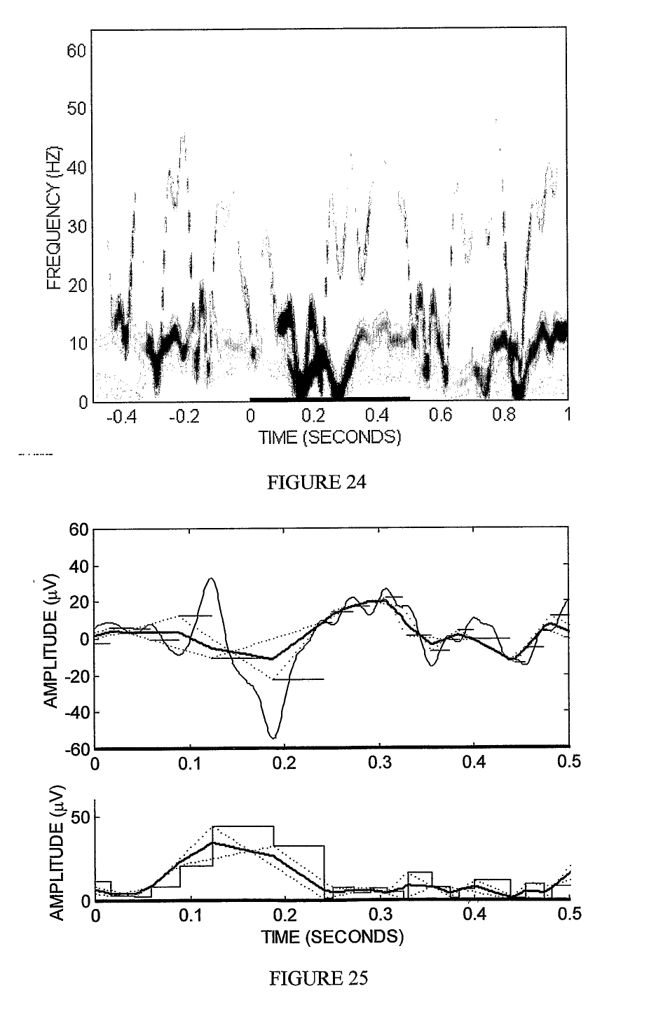

The original signal can be reconstructed according to equation (11). This particular approach of using smoothed local means to decompose the data is called the Local Mean Decomposition (LMD) and is described in [6]. The three highest frequency product functions generated using this approach are shown with their associated envelopes in FIG. 22. The corresponding instantaneous frequency results are shown in FIG. 23. The LMD instantaneous frequency and envelope (instantaneous amplitude) results are plotted together in the form of a Demodulated Signal time-frequency representation in FIG. 24.

One particular alternative method of creating local magnitude functions and local mean functions is to use linear interpolation in the smoothing process. For example the right (or left) end points of the local magnitudes associated with the maxima of the signal could be connected using linear interpolation (shown in the lower plot of FIG. 25 as a dotted line). The right (or left) endpoints of the local magnitudes associated with the minima of the signal could be similarly connected (also shown in the lower plot of FIG. 25 as a dotted line). The average of the resulting functions could then be smoothed using moving averaging to create a smoothly varying local magnitude function (shown as the bold line in the lower plot of FIG. 25). A corresponding local mean function could be created in the same way (shown in the upper plot of FIG. 25).

A further variation of the local mean decomposition involves calculating a smoothed local mean, subtracting this from the data, and then repeating this operation on the resulting signal and subsequent signals. The iteration is stopped when a signal is obtained which only contains half-wave oscillations which cross zero between each of their successive extrema. An envelope estimate for this signal can then be derived using a smoothed local magnitude. This envelope estimate is then used to amplitude demodulate the signal. If the resulting frequency modulated signal estimate has a flat envelope the process is halted, and instantaneous phase and frequency values can be calculated. Otherwise the process is repeated for the frequency modulated signal estimate, i.e. an envelope is derived for the frequency modulated signal estimate and used to amplitude demodulate it. The iteration process continues until a frequency modulated signal with a flat envelope is obtained. Meaningful instantaneous phase and frequency values can then be derived from this frequency modulated signal. So the revised process is:

$${h}_{11} ( t ) = x ( t ) - {m}_{11} ( t ) , \\ {h}_{12} ( t ) = {h}_{11} ( t ) - {m}_{12} ( t ) , \\ ⋮ \\ {h}_{1 n} ( t ) = {h}_{1 ( n - 1 )} ( t ) - {m}_{1 n} ( t ) , \qquad ( 25 )$$

where h₁ₙ(t) is a function which only contains oscillations which cross zero between each of their successive extrema. Then h₁ₙ(t) can be amplitude demodulated by iteration:

$${s}_{11} ( t ) = {h}_{11} ( t ) / {a}_{11} ( t ) , \\ {s}_{12} ( t ) = {s}_{11} ( t ) / {a}_{12} ( t ) , \\ ⋮ \\ {s}_{1 n} ( t ) = {s}_{1 n - 1} ( t ) / {a}_{1 n} ( t ) , \qquad ( 26 )$$

where s₁ₙ(t) is a frequency modulated signal. The corresponding envelope is then given by equation (18). A product function can be formed according to equation (23). This product function can then be subtracted from the original data, and the resulting signal processed according to equations (25) and (26). The iteration process continues according to equation (24).

### CONCLUSION

In this patent an iterative approach to amplitude and frequency demodulation of signals has been examined. Three related methods have been proposed which result in the representation of a signal as the product of an envelope signal and a possibly frequency modulated signal which itself has a constant envelope, or as a sum of such product signals. The objective has been to generate physically meaningful, non-negative, finite instantaneous frequency values. To this end an iterative amplitude demodulation approach is adopted to flatten the envelope of the original signal, producing a possibly frequency modulated signal which itself has a flat (constant) envelope, but which also has associated with it another, possibly time-varying, envelope signal. The first scheme can represent the signal very simply as being the single product of a possibly variable envelope and a possibly frequency modulated signal at each instant in time. The other schemes involve smoothing the data using moving averaging. Rather than smoothing the data itself, as in the second scheme, in LMD the local means are smoothed. In conclusion, it is important to emphasise that the new methods of signal processing described in this patent offer a very different, but physically meaningful way of interpreting data compared with traditional Fourier-based methods of analysis.

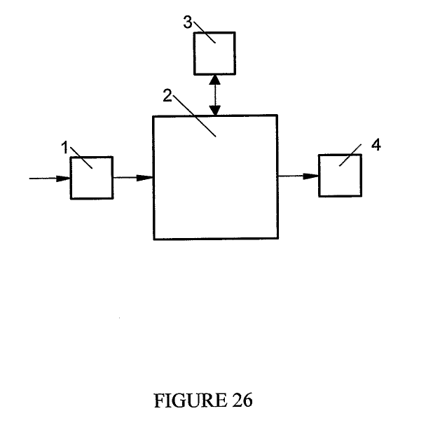

Representing a signal as being the product of an envelope and a frequency modulated signal from which a well-behaved instantaneous frequency can be derived, provides a very concise description of the signal. Such an approach can be used to analyse a wide variety of data. Commercial uses could include the analysis of financial data and seismogram data. Medical and scientific applications include the analysis of EEG data, blood pressure data, and speech signals. FIG. 26 shows an example of a such a signal processing apparatus. A signal is input into, or data recorded by, unit 1, which could, for example, be a blood pressure sensor, a medical imaging scanner, an electrode, a mobile telephone receiver, a television receiver, an earthquake sensor, a hearing aid receiver, or a computer mouse. The signal/data may then be processed according to one, some, or all of the methods described in this patent, by unit 3 which is incorporated in unit 2. Unit 2 could be an amplifier, a television, a mobile phone, a computer, a computer chip, a computer games console, medical cardiogram apparatus, seismogram apparatus, or a hearing aid, for example. The output can then be displayed by unit 4, which could be a computer monitor, a television screen, or some sort of sound speaker.

### REFERENCES

Gabor, D. 1946 Theory of communication. Proc. IEE (London) 93, 429-444.
Mandel, L. 1974 Interpretation of instantaneous frequencies. Am. J. Phys. 42, 840-846.
Melville, W. 1983 Wave modulation and breakdown. J. Fluid. Mech. 128, 489-506.
Boashash, B. 1992 Estimating and interpreting the instantaneous frequency of a signal—part 1. Proc. IEEE 80, 520-538.
Huang, N., Shen, Z., Long, S., Wu, M., Shih, H., Zheng Q., Yen, N-C., Tung, C., Liu, H. 1998 The empirical mode decomposition and the Hilbert spectrum for nonlinear and nonstationary time series analysis. Proc. R. Soc. Lond. A 454, 903-995.
Smith, J. 2005 The local mean decomposition and its application to EEG perception data. J. R. Soc. Interface published online.

1. A computer implemented set of procedures, or an article of manufacture comprising a computer implemented set of procedures, or an apparatus, which decomposes an input signal into the product of an envelope signal and a possibly frequency modulated signal from which an instantaneous phase and an instantaneous frequency can be derived, or into a set of such products, including:
a means of estimating an envelope signal and a frequency modulated signal, or a means of estimating a set of such envelope signals and frequency modulated signals; and
a means of multiplying each envelope signal estimate and each corresponding frequency modulated signal estimate together to form a product function, or a set of such product functions.

2. The computer implemented set of procedures, or the article of manufacture comprising the computer implemented set of procedures, or the apparatus, according to claim 1, for estimating an envelope of a signal including:
a means of interpolating data points between the maxima of the absolute value of the signal for those half-wave oscillators of signal which cross zero between their successive extrema; and
a means of setting the interpolated data points equal to the absolute value of the signal for those half-wave oscillations that do not cross zero between their successive extrema.

3. (canceled)

4. (canceled)

5. (canceled)

6. (canceled)

7. (canceled)

8. (canceled)

9. (canceled)

10. (canceled)

11. The computer implemented set of procedures, or the article of manufacture comprising:
the computer implemented set of procedures, or the apparatus, according to claim 1, for analyzing an input signal via the Local Mean Decomposition including: deriving a local mean function from the input signal; deriving a local magnitude function from the input signal; subtracting the local mean function from the input signal; and
dividing the resulting signal by the local magnitude function.

12. The computer implemented set of procedures, or the article of manufacture comprising the computer implemented set of procedures, or the apparatus, according to claim 11 for:
treating the signal which has been amplitude demodulated by the local magnitude function according to claim 11, as the new input signal, if the local magnitude function of that amplitude demodulated signal is not constant, and processing that amplitude demodulated signal estimate according to the procedure in claim 11; and
applying the procedure according to claim 11 to the resulting amplitude demodulated signal estimate and subsequent amplitude demodulated signal estimates by iterating until a signal with a constant envelope in the form of constant local magnitude function is obtained.

13. (canceled)

14. (canceled)

15. (canceled)

16. The computer implemented set of procedures, or the article of manufacture comprising the computer implemented set of procedures, or the apparatus, according to claim 11 for deriving the local mean function including:
calculating the mean value of the maximum and minimum points of each half-wave oscillation of a signal; and
setting all the points between the maximum and minimum points of each half-wave oscillation of the signal equal to this mean value.

17. The computer implemented set of procedures, or the article of manufacture comprising the computer implemented set of procedures, or the apparatus, according to claim 11 for deriving the local magnitude function including:
calculating the absolute value of the difference between the maximum and minimum points of each half-wave oscillation of the signal;
dividing this value by two;
and setting all the points between the maximum and minimum points of each half-wave oscillation of the signal equal to this value.

18. (canceled)

19. (canceled)

20. The computer implemented set of procedures, or the article of manufacture comprising the computer implemented set of procedures, or the apparatus, according to claim 1, for analyzing an input signal including:
deriving a local mean function from the input signal; and
subtracting the local mean function from the input signal.

21. (canceled)

22. (canceled)

23. (canceled)

24. (canceled)

25. (canceled)
